(19) United States
(12) Patent Application Publication
(10) Pub. No.: US 2022/0181662 A1
(43) Pub. Date: Jun. 9, 2022

(54) FUEL CELL AND FUEL CELL SYSTEM

(71) Applicant: TOYOTA JIDOSHA KABUSHIKI KAISHA, Toyota-shi (JP)

(72) Inventor: Takayuki SHIRAI, Susono-shi (JP)

(21) Appl. No.: 17/522,041

(22) Filed: Nov. 9, 2021

(30) Foreign Application Priority Data
Dec. 3, 2020 (JP) 2020-201239

(51) Int. Cl. H01M 8/1004; H01M 4/86

(52) U.S. Cl. CPC H01M 8/1004; H01M 4/8663

(57) ABSTRACT

Provided are a fuel cell and a fuel cell system capable of suppressing deterioration of the electrolyte membrane by iron-based foreign substances with a simple structure. The fuel cell includes: a MEGA and a nitrate compound, wherein the MEGA has an electrolyte membrane, an anode catalyst layer disposed on one surface of the electrolyte membrane, a cathode catalyst layer disposed on the other surface of the electrolyte membrane, an anode gas diffusion layer disposed on a surface of the anode catalyst layer which is opposite to a surface of the anode catalyst layer on the electrolyte membrane side, and a cathode gas diffusion layer disposed on a surface of the cathode catalyst layer which is opposite to a surface of the cathode catalyst layer on the electrolyte membrane side, and wherein the nitrate compound is disposed in the MEGA.

### FIELD

The present application relates to a fuel cell and a fuel cell system. More particularly, the present application relates to a fuel cell and a fuel cell system comprising a nitrate compound disposed in a MEGA of the fuel cell.

### BACKGROUND

Impurities containing metal ions may be unintentionally mixed into a fuel cell in manufacturing the fuel cell or due to the gas supplied to the fuel cell. Such impurities may cause deterioration of the electrolyte membrane and deterioration of the battery performance.

In response to such problems, Patent Document 1 discloses a technique of providing an acidic gas supply means in a fuel cell system to discharge a metal ion out of the system by supplying an acidic gas into an MEA of a fuel cell. In addition, Patent Document 2 discloses a technique of removing impurities such as salinity and metal ions that pass through an air filter and are directly mixed into a liquid fuel cell system, by an impurity removing device provided in a circulation portion.

### CITATION LIST

### Patent Literature

Patent Literature 1: JP 2008-152936 A

Patent Literature 2: JP 2005-11691 A

### SUMMARY

### Technical Problem

Among the impurities mixed in the fuel cell, there is an iron-based foreign substance derived from, for example, a manufacturing apparatus of the fuel cell. The fuel cell generates hydrogen peroxide during power generation. The present inventor has found that these iron-based foreign substance serve as a catalyst for promoting the conversion of hydrogen peroxide to radicals, and in the periphery of the iron-based foreign substances, thin films or holes of an electrolyte membrane are remarkably generated. In recent years, because a thin electrolyte membrane has been developed with the aim of reducing the cost of the fuel cell and improving the initial performance thereof, perforation of the electrolyte membrane etc. due to iron-based foreign substances is likely to occur. Therefore, the problem related to iron-based foreign substances is a very important issue in fuel cell development.

As described in Patent Documents 1 and 2, when an acidic gas supply means or an impurity removing device is separately provided in a fuel cell system, a manufacturing cost increases. In addition, although the technique of supplying the acidic gas of Patent Document 1 to the fuel cell can dissociate metal ions present in the fuel cell, it is difficult to dissolve and discharge solids such as iron-based foreign substances according to this technique. It is difficult for the impurity removing device of Patent Document 2 to eliminate iron-based foreign substances in the fuel cell. Therefore, according to the techniques of Patent Documents 1 and 2, it is not possible to sufficiently prevent local deterioration of the electrolyte membrane due to iron-based foreign substances.

In view of the above circumstances, it is an object of the present application to provide a fuel cell and a fuel cell system capable of suppressing deterioration of an electrolyte membrane due to iron-based foreign substances with a simple structure.

### Solution to Problem

As one means for solving the above problem, the present disclosure provides a fuel cell comprising a MEGA and a nitrate' compound, wherein the MEGA has an electrolyte membrane, an anode catalyst layer disposed on one surface of the electrolyte membrane, a cathode catalyst layer disposed on the other surface of the electrolyte membrane, an anode gas diffusion layer disposed on a surface of the anode catalyst layer which is opposite to a surface of the anode catalyst layer on the electrolyte membrane side, and a cathode gas diffusion layer disposed on a surface of the cathode catalyst layer which is opposite to a surface of the cathode catalyst layer on the electrolyte membrane side, and wherein the nitrate compound is disposed in the MEGA.

The above nitrate compound may contain at least one cation of Ce ions, Ag ions, and Co ions. Further, the above nitrate compound may be disposed in at least one place selected from the anode catalyst layer, the cathode catalyst layer, between the anode catalyst layer and the anode gas diffusion layer, and between the cathode catalyst layer and the cathode gas diffusion layer.

Further, the present disclosure provides, as one means for solving the above problem, a fuel cell system comprising the above described fuel cell, a fuel gas supply means for supplying a fuel gas to the fuel cell, and an oxidant gas supply means for supplying an oxidant gas to the fuel cell.

### Advantageous Effects

The fuel cell of the present disclosure is capable of dissolving iron-based foreign substances unintentionally introduced thereinto by a nitrate compound, and discharging the iron-based foreign substances out thereof. Accordingly, the fuel cell of the present disclosure can suppress deterioration of an electrolyte membrane due to iron-based foreign substances with a simple structure in which a nitrate compound is provided in a MEGA.

The fuel cell system of the present disclosure includes the fuel cell described above, which can suppress deterioration of the electrolyte membrane due to iron-based foreign substances with a simple structure without providing a facility for eliminating iron-based foreign substances in the system separately.

### BRIEF DESCRIPTION OF DRAWINGS

FIG. 1 is a schematic view of a cross section of a fuel cell according to an exemplary embodiment of the present disclosure; and

FIG. 2 is a block diagram of a fuel cell system incorporating the fuel cell of FIG. 1.

### DETAILED DESCRIPTION OF EMBODIMENTS

### Fuel Cell

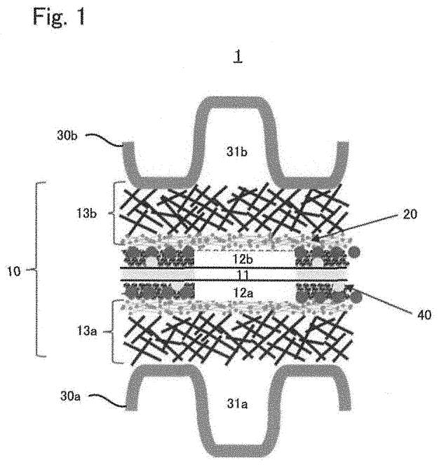

A fuel cell according to the present disclosure will be described with reference to a fuel cell 1 in FIG. 1, which is an embodiment. FIG. 1 shows a cross-sectional schematic view of the fuel cell 1.

As shown in FIG. 1, the fuel cell 1 comprises a MEGA 10 (Membrane Electrode Gas-diffusion-layer Assembly) and a nitrate compound 20. Further, the fuel cell 1 may be provided with a separator (anode separator 30a, cathode separator 30b) on each of the surfaces of the MEGA 10 in the stacking direction.

In some cases, the fuel cell 1 contains an iron-based foreign substance 40. Here, the “iron-based foreign substance” is an impurity containing an Fe element unintentionally introduced into the fuel cell 1 when manufacturing the fuel cell or by a gas supplied to the fuel cell. Since the Fe concentration (Fe ion concentration) tends to be high in the vicinity of the iron-based foreign substance 40, local deterioration such as thinning and perforation of an electrolyte membrane 11 occurs. In order to suppress such a problem, the fuel cell 1 includes the nitrate compound 20.

### MEGA 10

The MEGA 10 has the electrolyte membrane 11, an anode catalyst layer 12a disposed on one surface of the electrolyte membrane 11, a cathode catalyst layer 12b disposed on the other surface of the electrolyte membrane 11, an anode gas diffusion layer 13a disposed on a surface of the anode catalyst layer 12a opposite to the other surface thereof on the electrolyte membrane 11 side, and a cathode gas diffusion layer 13b disposed on a surface of the cathode catalyst layer 12b opposite to the other surface thereof on the electrolyte membrane 11 side.

Throughout this specification, the anode catalyst layer 12a and/or the cathode catalyst layer 12b may be simply referred to as (a) catalyst layer(s), and the anode gas diffusion layer 13a and/or the cathode gas diffusion layer 13b may be simply referred to as (a) gas diffusion layer(s).

### Electrolyte Membrane 11

The electrolyte membrane 11 is a solid polymer thin film exhibiting good proton conductivity in a wet state. As such an electrolyte membrane 11, a known electrolyte membrane may be used, and an example thereof is a fluororesin polymer film having high hydrogen ion conductivity represented by a perfluorocarbon sulfonic acid resin film. The thickness and the like of the electrolyte membrane 11 may be appropriately set according to the purpose.

### Anode Catalyst Layer 12a

The anode catalyst layer 12a is disposed on one surface of the electrolyte membrane 11, and has a role of taking out protons and electrons from a fuel gas (e.g., hydrogen gas) supplied to the fuel cell 1. A platinum-based catalyst is used for the anode catalyst layer 12a. In addition, carbon particles on which a catalyst is supported may be used for the anode catalyst layer 12a. The thickness and the like of the anode catalyst layer 12a may be appropriately set according to the purpose.

### Cathode Catalyst Layer 12b

The cathode catalyst layer 12b is disposed on the other surface of the electrolyte membrane 11, and has a role of generating water from an oxidant gas (e.g., air) supplied to the fuel cell 1, protons that have migrated from the anode side via the electrolyte membrane 11, and electrons. The cathode catalyst layer 12b may be composed of the material same as that of the anode catalyst layer 12a. The thickness and the like of the cathode catalyst layer 12b may be appropriately set according to the purpose.

Here, the electrolyte membrane 11, the anode catalyst layer 12a, and the cathode catalyst layer 12b together are referred to as MEA (Membrane Electrode Assembly).

### Anode Gas Diffusion Layer 13a

The anode gas diffusion layer 13a is disposed on a surface of the anode catalyst layer 12a opposite to the other surface thereof on the electrolyte membrane 11 side, and has a role of diffusing the fuel gas along the surface direction of the electrolyte membrane 11. As the anode gas diffusion layer 13a, a known anode gas diffusion layer may be used. For example, a porous conductive base material such as carbon fiber, graphite fiber, and metal foam may be used. The thickness or the like of the anode gas diffusion layer 13a may be appropriately set according to the purpose.

### Cathode Gas Diffusion Layer 13b

The cathode gas diffusion layer 13b is disposed on a surface of the cathode catalyst layer 12b opposite to the other surface thereof on the electrolyte membrane 11 side, and has a role of diffusing the oxidant gas along the surface direction of the electrolyte membrane 11. The cathode gas diffusion layer 13b may be composed of the same material as the anode gas diffusion layer 13a. The thickness and the like of the cathode gas diffusion layer 13b may be appropriately set according to the purpose.

### Nitrate Compound 20

The nitrate compound 20 is disposed within the MEGA 10. The nitrate compound 20 disposed in the MEGA 10 is dissolved by water generated during power generation of the fuel cell 1. Then, since the nitrate compound 20 is ionized, the pH in the fuel cell 1 (in the MEGA 10) decreases. Since the iron-based foreign substance present in the fuel cell 1 is dissolved due to the decrease in pH, the dissolved iron-based foreign substance 40 diffuses widely into the MEGA 10 and is discharged out of the fuel cell 1. In this way, the fuel cell 1 suppresses local deterioration of the electrolyte membrane 11 due to the iron-based foreign substance 40.

Although it is also conceivable to use sulfate, hydrochloride, or the like as a salt for dissolving the iron-based foreign substance 40, these may poison the catalyst layer, particularly platinum, and therefore, the nitrate compound 20 is adopted in the fuel cell 1. The nitrate compound 20 is unlikely to poison the catalyst.

The nitrate compound 20 is a compound obtained by ionic bond of nitrate ions and cations. The type of the cations contained in the nitrate compound 20 is not particularly limited as long as the cations are capable of ionically bonding with nitrate ions. Examples of the cations include a proton, organic-based and inorganic-based cations, and a metal cation.

Among them, it is preferable that the nitrate compound 20 contain at least one type of cations among Ce ions, Ag ions, and Co ions. This is because these cations are considered to have a function of decomposing hydrogen peroxide, which is one of the causes of deterioration of the electrolyte membrane 11. Further, cations may be replaced with an acidic functional group (such as a sulfonic acid group) in the electrolyte membrane 11, to lower the proton conductivity of the electrolyte membrane 11 to adversely affect the power generation performance. Therefore, it is preferable to use any of those cations having a small valence from the viewpoint of reducing adverse effects due to cations.

The nitrate compound 20 has only to be disposed in the MEGA 10. In some cases, a water-repellent material is contained in the gas diffusion layer, which makes it difficult for generated water by power generation to enter. Thus, it is preferable that the nitrate compound 20 be disposed in a place other than the gas diffusion layers. In other words, it is preferable that the nitrate compound 20 be disposed in at least one place selected from the anode catalyst layer 12a, the cathode catalyst layer 12b, between the anode catalyst layer 12a and the anode gas diffusion layer 13a, and between the cathode catalyst layer 12b and the cathode gas diffusion layer 13b. By arranging the nitrate compound 20 in any of these places, the nitrate compound 20 is easily brought into contact with the generated water and is easily dissolved. In FIG. 1, the nitrate compound 20 is disposed between the anode catalyst layer 12a and the anode gas diffusion layer 13a and between the cathode catalyst layer 12b and the cathode gas diffusion layer 13b.

The nitrate compound 20 brings about an effect of removing the iron-based foreign substance 40 if disposed even a little in the MEGA 10. If the nitrate compound 20 is, however, excessively disposed, the above-described adverse effect due to cations may occur, and the initial power generation performance may be deteriorated. Therefore, it is preferable to predict the content of the iron-based foreign substance 40 mixed in the fuel cell 1 and to arrange an appropriate amount of the nitrate compound 20 in the MEGA 10. Such a content can be obtained by experiments.

For example, when the nitrate compound 20 is disposed in the catalyst layers or between the catalyst layers and the gas diffusion layers, the amount of the nitrate compound 20 disposed is preferably 2 μg/cm² or more, and even more preferably 6 μg/cm² or more. Further, the amount of the nitrate compound 20 disposed is preferably 24 μg/cm² or less, and even more preferably 12 μg/cm² or less.

### Anode Separator 30a

The anode separator 30a is disposed on a surface of the anode gas diffusion layer 13a opposite to the other surface thereof on the anode catalyst layer 12a side, and has a role of supplying the fuel gas supplied to the fuel cell 1 along the surface direction of the electrolyte membrane 11. The anode separator 30a has an uneven shape, and a concave portion having an opening on the MEGA 10 side becomes a fuel-gas flow path 31a. The anode separator 30a may be constituted of a known material, and examples thereof include metal materials such as stainless steel, and carbon materials such as carbon composite materials.

### Cathode Separator 30b

The cathode separator 30b is disposed on a surface of the cathode gas diffusion layer 13b opposite to other surface thereof on the cathode catalyst layer 12b side, and has a role of supplying the oxidant gas supplied to the fuel cell 1 along the surface direction of the electrolyte membrane 11. The cathode separator 30b has an uneven shape, and a concave portion having an opening on the MEGA 10 side becomes an oxidant gas flow path 31b. The material constituting the cathode separator 30b may be the same as that of the anode separator 30a.

Here, the anode separator 30a and the cathode separator 30b may be each provided with a cooling water flow path for flowing cooling water for adjusting the temperature of the fuel cell 1. In addition, throughout this specification, the anode separator 30a and/or the cathode separator 30b may simply be referred to as (a) separator(s).

### Method for Producing Fuel Cell 1

The fuel cell 1 may be manufactured by known steps except that the nitrate compound 20 is disposed in the MEGA 10. For example, first, an ink (catalyst ink) containing a catalyst is applied to a predetermined resin sheet, and thereafter the resin sheet and the electrolyte membrane 11 are pressure-bonded to transfer the catalyst layer to the electrolyte membrane 11, which is performed on the anode side and the cathode side, respectively. Next, a gas diffusion layer is disposed on each of both surfaces of the electrolyte membrane 11 on which the catalyst layers are disposed. This produces the MEGA 10. Further, separators may be disposed on both surfaces of the MEGA 10 in the lamination direction, respectively. Here, in producing the MEGA 10, the nitrate compound 20 is arranged at a predetermined position. The method of arranging the nitrate compound 20 is not particularly limited, and a powder of the nitrate compound 20 may be simply arranged, or may be mixed with the above catalyst ink to be arranged. When the nitrate compound 20 is arranged in the MEGA 10 by mixing into the catalyst ink, the nitrate compound 20 is disposed within the catalyst layers or between the catalyst layers and the gas diffusion layers. Further, a solution of the nitrate compound may be sprayed onto any position of the MEGA 10 and placed. The fuel cell 1 can be manufactured by such a method.

Thus, the fuel cell according to the present disclosure has been described using the fuel cell 1 which is an embodiment. The fuel cell according to the present disclosure is capable of dissolving unintentionally mixed iron-based foreign substances by a nitrate compound and discharging the substances out of the fuel cell. Accordingly, the fuel cell according to the present disclosure makes it possible to suppress deterioration of an electrolyte membrane due to iron-based foreign substances with a simple structure in which a nitrate compound is provided in a MEGA. Further, by dissolving iron-based foreign substances, stress in the fuel cell can be reduced.

### Fuel Cell System

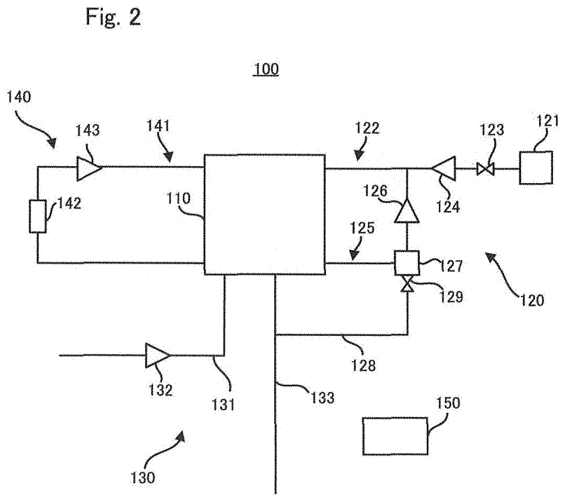

Next, a fuel cell system using the fuel cell described above will be described with reference to a fuel cell system 100 which is an embodiment. FIG. 2 shows a block diagram of the fuel cell system 100.

As shown in FIG. 2, the fuel cell system 100 includes a fuel cell 110, a fuel gas piping section 120, an oxidant gas piping section 130, a cooling water piping section 140, and a control means 150. Hereinafter, the configuration of each of the foregoing will be described.

### Fuel Cell 110

As the fuel cell 110, the fuel cell 1 described above may be used. Further, as the fuel cell 110, a fuel cell stack of a plurality of stacked fuel cells 1 may be used. The configuration of the fuel cell stack other than the fuel cell 1 may be a known configuration. Since containing a nitrate compound in a MEGA as described above, the fuel cell 110 is capable of suppressing the deterioration of the electrolyte membrane due to iron-based foreign substances with a simple structure without separately providing a facility for eliminating the iron-based foreign substances in the system.

### Fuel Gas Piping Section 120

The fuel gas piping section 120 is for supplying the fuel gas to the anode of the fuel cell 110. The fuel gas piping section 120 includes a fuel gas supply source 121, a fuel gas supply flow path 122 which is a pipe for letting the fuel gas supplied from the fuel gas supply source 121 flow, a circulation flow path 125 which is a pipe for letting a fuel off gas discharged from the fuel cell 110 flow and refluxing the fuel off gas to the fuel gas supply flow path 122, and an exhaust and discharge flow path 128 for discharging the fuel off gas and a liquid component. Further, the fuel gas piping section 120 may be provided with any members that are generally provided in the fuel gas pipe section.

The fuel gas supply source 121 is, for example, formed of a high-pressure hydrogen tank and a hydrogen storage alloy, to store, for example, a hydrogen gas of 35 MPa or 70 MPa. When a shut-off valve is opened, the fuel gas flows out from the fuel gas supply source 121 to the fuel gas supply flow path 122.

One end of the fuel gas supply flow path 122 is connected to the fuel gas supply source 121 and the other end thereof is connected to the anode of the fuel cell 110. The fuel gas supply flow path 122 is a pipe for letting the fuel gas flow to the anode. The fuel gas supply flow path 122 includes a regulator 123 and an injector 124 in this order from the upstream side (fuel gas supply source 121 side). Further, between the fuel gas supply source 121 and the regulator 123, the shut-off valve or the like for shutting off the supply of the fuel gas may be provided. The fuel gas is reduced in pressure by the regulator 123 and the injector 124, e.g., to about 200 kPa, and is supplied to the fuel cell 110.

The regulator 123 regulates the upstream pressure (primary pressure) to a preset secondary pressure. The regulator 123 is not particularly limited. A known regulator may be used as the regulator 123. By placing the regulator 123 upstream the injector 124, the upstream pressure of the injector 124 can be effectively reduced.

The injector 124 is a fuel gas supply means and is disposed in the fuel gas supply flow path 122, so that the fuel gas such that the pressure thereof is regulated by the regulator 123 can be supplied to the anode of the fuel cell 110 at a constant flow rate. The supply of the fuel gas from the fuel gas supply source 121 to the fuel cell 110 is controlled by a solenoid operated on-off valve of the injector 124.

The circulation flow path 125 is a pipe for circulating the fuel off gas discharged from the anode to the fuel gas supply flow path 122, and includes a pump 126 as a power for refluxing the fuel off gas to the fuel gas supply flow path 122. Further, the circulation flow path 125 is arranged with a gas-liquid separator 127 capable of separating the liquid component and a gas component of the fuel off gas. The liquid component is mainly water generated by an electrochemical reaction of the fuel cell 110, and the gas component is the fuel gas. The separated liquid component is discharged, and the gas component is circulated in the fuel gas supply flow path 122.

To the side of the gas-liquid separator 127 where the liquid component is discharged, the exhaust and discharge flow path 128 is connected. The exhaust and discharge flow path 128 is opened and closed by an exhaust and discharge valve 129. The exhaust and discharge valve 129 is operated by a command from the control means 150, and discharges the fuel off gas and the liquid component containing impurities to the outside via the exhaust and discharge flow path 128. By opening the exhaust and discharge valve 129, the concentration of impurities in the fuel off gas in the circulation flow path 125 decreases, and the concentration of the fuel gas in the fuel off gas to be circulated increases. The exhaust and discharge flow path 128 is connected to an oxidant off gas exhaust flow path 133 to be described later. Gas and liquid are discharged through the oxidant off gas exhaust flow path 133.

### Oxidant Gas Piping Section 130

The oxidant gas piping portion 130 is for supplying the oxidant gas to the cathode of the fuel cell 110. The oxidant gas piping portion 130 includes an oxidant gas supply flow path 131 which is a pipe for letting the oxidant gas flow into the cathode, an air compressor 132 which is disposed on the oxidant gas supply flow path 131, and an oxidant off gas exhaust flow path 133 which is a pipe for discharging an oxidant off gas discharged from the cathode. In addition, the oxidant gas piping section 130 may be provided with any other members generally provided in the oxidant gas piping section.

The oxidant gas supply flow path 131 is a pipe for letting air taken from outside air flow into the cathode when the oxidant gas is, for example, air. The air compressor 132 is an oxidant gas supply means and is disposed on the oxidant gas supply flow path 131 so that the oxidant gas can be supplied to the cathode. The oxidant off gas exhaust flow path 133 is a pipe for discharging the oxidant off gas discharged from the cathode. The exhaust and discharge flow path 128 is connected to the oxidant off gas exhaust flow path 133, and the fuel off gas and the oxidant off gas pass through the oxidant off gas exhaust flow path 133 and are discharged to the outside.

### Cooling Water Piping Section 140

The cooling water piping section 140 is for cooling the fuel cell 110 via cooling water. The cooling water piping section 140 includes a cooling water flow path 141 that is a pipe connecting the inlet and outlet of cooling water in the fuel cell 110, and for circulating the cooling water, a radiator 142, and a cooling water supply means 143. Further, the cooling water piping section 140 may be provided with any other member generally provided in the cooling water pipe section.

The cooling water flow path 141 is a pipe connecting the inlet and outlet in the cooling water in the fuel cell 110, and for circulating the cooling water. The radiator 142 performs heat exchange between the cooling water flowing through the cooling water flow path 141 and the outside air, and cools the cooling water. The cooling water supply means 143 is power for the cooling water circulating through the cooling water flow path 141.

### Control Means 150

The control means 150 is a computer system including a CPU, a ROM, a RAM, an input-output interface, and the like, and controls each part of the fuel cell system 100.

The fuel cell system according to the present disclosure has been described above using the fuel cell system 100 as one embodiment. The fuel cell system according to the present disclosure including the fuel cell according to the present disclosure makes it possible to suppress the deterioration of the electrolyte membrane due to iron-based foreign substances with a simple structure without providing a facility for eliminating the iron-based foreign substances in the system separately.

### EXAMPLES

Hereinafter, the present disclosure will be further described based on Examples.

### Preparation of Evaluation Cell

### Example

A cerium nitrate solution was added to an An catalyst ink and the An catalyst ink was applied to a Teflon (registered trademark) sheet. Thereafter, a Teflon (registered trademark) sheet was pressure-bonded to an electrolyte membrane, so that an An catalyst layer was transferred to the electrolyte membrane. The amount of the An catalyst layer was 6 μg/cm². The foregoing process was performed on both surfaces of the electrolyte membrane. Gas diffusion layers were arranged on both surfaces of the electrolyte membrane, respectively. At this time, a powder of an iron foreign substance having a particle diameter of 200 μm was placed on the catalyst layers. The obtained MEGA was placed in a predetermined case to prepare a fuel cell according to Example.

### Comparative Example

A fuel cell according to Comparative Example was prepared in the same manner as in Example except that a cerium nitrate solution was not added to an An catalyst ink.

### Evaluation

Each of the prepared fuel cell was subjected to running-in and a 300-hour endurance test. The particle size of the iron foreign substance and the Fe concentration of the electrolyte membrane just under the iron foreign substance after the test were measured. The results are shown in Table 1.

Here, running-in is to operate the fuel cell under the condition leading to high current density, to sufficiently generate water, to adjust the MEGA to an appropriate environment; and the endurance test is to operate the fuel cell continuously for a long time under the condition leading to low current density. In the endurance test, the generation of water is not sufficient, and the inside of the MEGA is in a relatively dry environment.

The particle size of the iron foreign substance was measured using transmission electron X-rays. The Fe-concentration of the electrolyte membrane just under the iron foreign substance was measured using secondary ion-mass spectrometry (SIMS).

TABLE 1

| | Comparative | |
|---|---|---|
| | Example | Example |
| Addition of nitrate compound | No | Yes |
| Initial particle size of iron foreign substance (μm) | 200 | 200 |
| Particle size of iron foreign substance after test (μm) | 183 | 70 |
| Fe concentration just under iron foreign substance | 0.88 | 0.22 |
| (μg/cm²) | | |

From Table 1, it was confirmed that the particle size of the iron foreign substance in Example was remarkably reduced as compared with Comparative Example. Further, the Fe concentration in Example was also confirmed to be significantly low as compared with Comparative Example. From these results, it is considered that, by arranging a nitrate compound in a MEGA, iron-based foreign substances can be dissolved and discharged out of the fuel cell. Accordingly, it is considered that the fuel cell according to the present disclosure is capable of suppressing local deterioration of the electrolyte membrane.

### Reference Signs List

1 fuel cell

10 MEGA

11 electrolyte membrane

12a anode catalyst layer

12b cathode catalyst layer

13a anode gas diffusion layer

13b cathode gas diffusion layer

20 nitrate compound

30a anode separator

30b cathode separator

31a fuel gas flow path

31b oxidant gas flow path

100 fuel cell system

110 fuel cell

120 fuel gas piping section

121 fuel gas supply source

122 fuel gas supply flow path

123 regulator

124 injector

125 circulation flow path

126 pump

127 gas-liquid separator

128 exhaust and discharge flow path

129 exhaust and discharge valve

130 oxidant gas piping section

131 oxidant gas supply flow path

132 air compressor

133 oxidant off gas exhaust flow path

140 cooling water piping section

141 cooling water flow path

142 radiator

143 cooling water supply means

150 control means

What is claimed is:

1. A fuel cell comprising a MEGA and a nitrate compound,
wherein the MEGA has an electrolyte membrane, an anode catalyst layer disposed on one surface of the electrolyte membrane, a cathode catalyst layer disposed on another surface of the electrolyte membrane, an anode gas diffusion layer disposed on a surface of the anode catalyst layer, the surface being opposite to a surface of the anode catalyst layer on the electrolyte membrane side, and a cathode gas diffusion layer disposed on a surface of the cathode catalyst layer, the surface being opposite to a surface of the cathode catalyst layer on the electrolyte membrane side, and
wherein the nitrate compound is disposed in the MEGA.

2. The fuel cell according to claim 1, wherein the nitrate compound comprises at least one cation of Ce ions, Ag ions, and Co ions.

3. The fuel cell according to claim 1, wherein the nitrate compound is disposed in at least one place selected from the anode catalyst layer, the cathode catalyst layer, between the anode catalyst layer and the anode gas diffusion layer, and between the cathode catalyst layer and the cathode gas diffusion layer.

4. A fuel cell system comprising: the fuel cell according to claim 1; a fuel gas supply means for supplying a fuel gas to the fuel cell; and an oxidant gas supply means for supplying an oxidant gas to the fuel cell.
